(19) United States
(12) Patent Application Publication
(10) Pub. No.: US 2010/0257312 A1
(43) Pub. Date: Oct. 7, 2010

(54) Data Storage Methods and Apparatus

(75) Inventor: Andrew Twigg, London (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Acunu Limited, London (GB)

(21) Appl. No.: 12/752,673

(22) Filed: Apr. 1, 2010

(30) Foreign Application Priority Data
Apr. 1, 2009 (GB) 0905638.3

(51) Int. Cl. G06F 12/00

(52) U.S. Cl. 711/114; 711/E12.001

(57) ABSTRACT

A method of storing data on a plurality of physical data storage drives, each of which and can be switched between an operative state in which there is relatively high power consumption and data can be read from and written to the drive; and an inoperative state in which there is relatively low power consumption and data cannot be read from and written to the drive or at least can only be read or written at a relatively low speed.

This invention relates to data storage methods and apparatus, and is more particularly concerned with arrangements for storing the data required by an organisation whilst reducing the number of physical drives that need to be active at any particular time.

Many large enterprise storage server systems are highly underutilized in terms of performance. Typically less than 30% of data is needed at any time, and often significantly less. Around 70% of the power consumed by storage appliances is due to spinning disks, so an obvious target for power saving is to reduce the number of spinning disks. As such, spinning disks down is not a new idea and is used in desktop and laptop personal computers to reduce energy consumption. However, for large parallel disk arrays in enterprise storage servers, the situation is quite different. Currently, commercially available high-performance storage systems (with the exception of archival systems, which are discussed below) keep all disks spinning all the time. For example, they will try to move inactive data to lower-power (or lower-tiered) disks such as SATA drives, but still never actually turn them off, so that the overall benefits are fairly small. There are two reasons for this. Firstly, even a few unpredictable spin-up delays lead to unacceptable performance. It takes around 15-20 seconds to spin up a disk, and about 5 ms to access a block of data once spun up, a delay penalty of around 4000 times. In practice if, say, 0.1% of requests incur spin-up delay, the average delay increases from 5 ms to about 25 ms. Secondly, striping or otherwise distributing load across several disks means that no disk is idle long enough to spin down. To achieve performance and fault-tolerance, data is often striped across many disks (as with many RAID schemes). Since the load is spread over many disks, this means that even under low system load, the probability that a given disk will be idle long enough to spin down is extremely low. Thus, even though a current load could be supported by a few disks, it is instead spread over many disks spinning unnecessarily.

There have been various proposals for power efficient data storage falls into several categories. For example there are file or block migration techniques. Zhu et al. describe such a system called “Hibernator” in SIGOPS Oper. Syst. Rev., 39(5):177-190, 2005. They propose to use several tiers of disks, each with different power consumption and speed. They divide time into epochs and try to predict energy costs in the next epoch based on previous accesses, then solve an optimization problem to decide which tiers data should occupy in the next epoch. Previous to the above, Zhu et al. have also published a very similar, but less developed system called “Chameleon: A self-adaptive energy-efficient performance-aware RAID”. Compellent (www.compellent.com) describe a technique called automated tiered storage that moves data between different tiers of disks (fibre-channel, SSD, SATA, etc) depending on its time of last access and access frequency. Pinheiro et al., “Energy conservation techniques for disk array-based servers”, ICS '04: Proceedings of the 18th annual international conference on Supercomputing, pages 68-78, New York USA, 2004, describe a similar technique called popular data concentration (driveC) that distributes data across disks so that, typically, the first disk contains the most recently accessed (or most “popular”) data, the second disk contains the second most popular data, and so on. Periodically, the system re-computes a new layout based on the new popularities of data, and migrates data between disks as appropriate. The above techniques primarily focus on moving recently-accessed or popular data to tiers of faster storage. They require constantly re-computing new data layouts for the inactive data, causing substantial relocation to maintain the desired layout.

Another category is log file systems, or write-redirection. Ganesh et al. “Optimizing power consumption in large scale storage systems”, HOTOS '07: Proceedings of the 11th USENIX workshop on hot topics in operating systems, pages 1-6, Berkeley, Calif., USA, 2007, describe a system that uses a log file system to direct writes to a small set of disks, with the aim of turning disks on when read loads are low. Narayanan et al., “Write off-loading: Practical power management for enterprise storage”, Trans. Storage, 4(3):1-23, 2008, describe a technique called write off-loading that uses a few buffer disks arranged as a log file system to buffer writes before writing them to a static layout on the main disks. Neither of these techniques can guarantee that active volume data can be accessed without a spin up delay.

A further category is RAID modifications and caching techniques. Weddle et al., “Energy conservation techniques for disk array-based servers”, ICS '04: Proceedings of the 18th annual international conference on Supercomputing, pages 68-78, New York, USA, 2004, describe a modification of RAID called PARAID. It uses a modified striping pattern to adapt to the system load by varying the number of active disks. Those physical disks not involved in the active stripes can be turned off. Carrera et al., “Conserving disk energy in network servers”, ICS '03: Proceedings of the 17th annual international conference on Supercomputing, pages 86-97, New York, USA, 2003, propose to let each high-power disk be mirrored by a low-power disk, and to use multi-speed disks, varying the speed depending on the system load. Li et al., “EERAID: energy efficient redundant and inexpensive disk array”, Proceedings of the 11th workshop on ACM SIGOPS European workshop, page 29, New York, N.Y., USA, 2004, describe a technique called EERAID (“energy-efficient redundant and inexpensive disk array”) that operates at the scheduling level. They present several scheduling schemes for serving block requests on modifications of RAID 1 and RAID 5 disk layouts. Zhu et al., “Power-aware storage cache management”, IEEE Trans. Comput., 54(5):587-602, 2005, describe a power-aware storage cache. Their work tries to save energy by more carefully managing the eviction and pre-fetching policy of the caching algorithm. None of these techniques distinguish between active and inactive volumes, nor do they modify the data layout for these cases.

Another category is the Massive Array of Idle Disks (MAID). Colarelli et al., “MAID: Massive Arrays of Idle Disks for storage archives”, Supercomputing '02: Proceedings of the 2002 ACM/IEEE conference on Supercomputing, pages 1-11, Los Alamitos, Calif., USA, 2002, describe a technique called MAID. They use a small cache of extra storage devices (disk drives or SSD or memory or other), and let the disks not in the cache turn off or spin down after a certain period of inactivity (or a similar policy). The cache is assumed to be small, so that certainly not all active volume data can be stored in the cache. The data layout is static, and unless all the active volume data is stored in the cache, there is no guarantee that all active data can be accessed without spin up delays. Poor use is made of the spinning disks (for example, many disks may need to spin to support a small amount of data). Since the number of disks spinning at any time is bounded (e.g. by packing drives very closely), this will translate into significant delays, and possible reliability concerns, as drives are repeatedly spun up and down in quick succession. MAID systems may incur unpredictable spin up delays as disks are spun up to access the required data from active volumes.

Proposals for energy efficient storage can also be found in, for example, U.S. Pat. Nos. 7,404,102, 7,398,418, 7,493,514, 7,266,668, 7,181,578, 7,210,005, 7,035,972 7,380,060, and 7,330,931.

The present invention provides a method of storing data on a plurality of physical data storage drives, each of which and can be switched between an operative state in which there is relatively high power consumption and data can be read from and written to the drive; and an inoperative state in which there is relatively low power consumption and data cannot be read from and written to the drive or at least can only be read or written at a relatively low speed. For example, the drive may have a data storage component and in the operative state the data storage component is moving to permit data to be read from or written to the data storage component, and in the inoperative state the data storage component is stationary or moving at a lower speed. Typically, the data storage component will be a disk which is spun continuously when the drive is in its operative state. However, the invention is applicable to data storage drives which do not use spinning disks, such as some of the drives disclosed in WO2004/038701.

An active volume containing data which is currently active and in respect of which there is a relatively high likelihood of read requests, is stored across a first number of drives in an active set of a plurality of drives which are normally maintained in the operative state. To reduce the number of drives which have to be within the active set of drives, when a volume is identified as containing only data which has become inactive and in respect of which there is a relatively low likelihood of read requests, that inactive volume is transferred from the active set of drives to a second number of drives within an inactive set of a plurality of drives which are normally maintained in the inoperative state. To achieve this, a second number of the drives in the inactive set to hold the inactive volume are made operative temporarily, the inactive volume is transferred from the active set of drives to the drives in the inactive set of drives which have been made operative, and those drives in the inactive set of drives to which the inactive volume has been transferred are subsequently made inoperative.

When there is a subsequent read or write request in respect of an inactive volume stored within the inactive set of drives, the drives in the inactive set which hold the inactive volume are made operative temporarily, the inactive volume is transferred from the inactive set of drives to the drives in the active set of drives and becomes an active volume, and those drives in the inactive set of drives from which the inactive volume has been transferred are made inoperative again.

The data storage layouts for the active set of drives and the inactive set of drives are preferably different, such that the first number of drives in the active set for holding a volume when active, is greater than the second number of drives in the inactive set for holding that volume when inactive.

The intention is that that by rearranging active data across the active set of drives after an inactive volume has been transferred, it will be possible to reduce the total number of drives required in the active set to accommodate all of the active volumes. Additionally, as new data is added to the active set of drives, space freed up by the transfer of inactive volumes may be such that the new active data—whether completely new or a previously inactive volume that has been made active—can be accommodated without the need to add further drives to the active set.

A volume can be considered as a “virtual disk” or as a collection of various different data files, although in some applications a volume could only contain one large file.

The invention may be expressed in terms of a number of aspects embodying some or all of the above features. For example, viewed one aspect the invention provides a method of storing data on a plurality of physical data storage drives, each of which has a data storage component and can be switched between an operative state in which there is relatively high energy usage, and an inoperative state in which there is relatively low energy usage; wherein an active volume containing data which is currently active is stored across a plurality of drives being a first number of drives in an active set of the plurality of drives which are normally maintained in the operative state; when a volume is identified as containing only data which has become inactive, that inactive volume is transferred from the active set of drives and stored across a plurality of drives being a second number of drives within an inactive set of the plurality of drives which are normally maintained in the inoperative state; when there is a subsequent read or write request in respect of an inactive volume stored within the inactive set of drives, the inactive volume is transferred from the inactive set of drives to the drives in the active set of drives and becomes an active volume; and wherein the data storage layouts for the active set of drives and the inactive set of drives are different, and the data storage layout for the inactive drives includes a plurality of regions at predetermined different levels of increasing data storage capacity and is such that (a) when an inactive volume is transferred in its entirety to the inactive set of drives it is allocated to the smallest capacity region that will accommodate the data of the volume; and (b) when additional data only is to be added to a volume on the inactive set of drives the additional data is firstly placed in the current highest capacity region containing data for that volume until that current highest capacity region is full; and if there is remaining data to be added to the volume that remaining data is placed in the lowest capacity region that (i) will accommodate that remaining data and (ii) is of the same capacity as, or a higher capacity than, the currently highest capacity region.

In a preferred embodiment, when there is the remaining data to be added to the volume that remaining data will only be placed in a region at the same level as, is the same capacity as, the currently highest capacity region, if that is the only region containing data for the volume.

Viewed from another aspect of the invention there is provided an apparatus for storing data, the apparatus comprising a plurality of physical data storage drives, each of which can be switched between an operative state in which there is relatively high energy usage, and an inoperative state in which there is relatively low energy usage; wherein the apparatus comprises data processing means configured such that:

an active volume containing data which is currently active is stored across a plurality of drives being a first number of drives in an active set of the plurality of drives which are normally maintained in the operative state; when a volume is identified as containing only data which has become inactive, that inactive volume is transferred from the active set of drives and stored across a plurality of drives being a second number of drives within an inactive set of the plurality of drives which are normally maintained in the inoperative state; when there is a subsequent read or write request in respect of an inactive volume stored within the inactive set of drives, the inactive volume is transferred from the inactive set of drives to the drives in the active set of drives and becomes an active volume; and wherein the data storage layouts for the active set of drives and the inactive set of drives are different, and the data storage layout for the inactive drives includes a plurality of regions at predetermined different levels of increasing data storage capacity and is such that (a) when an inactive volume is transferred in its entirety to the inactive set of drives it is allocated to the smallest capacity region that will accommodate the data of the volume; and (b) when additional data only is to be added to a volume on the inactive set of drives the additional data is firstly placed in the current highest capacity region containing data for that volume until that current highest capacity region is full; and if there is remaining data to be added to the volume that remaining data is placed in the lowest capacity region that (i) will accommodate that remaining data and (ii) is of the same capacity as, or a higher capacity than, the currently highest capacity region.

Viewed from another aspect of the invention there is provided a computer software product containing instructions which when run on data processing means will configure the data processing means to control an apparatus for storing data, the apparatus comprising a plurality of physical data storage drives, each of which an operative state in which there is relatively high energy usage and an inoperative state in which there is relatively low energy usage; wherein the instructions are arranged to configure the data processing means such that:

an active volume containing data which is currently active is stored across a plurality of drives being a first number of drives in an active set of the plurality of drives which are normally maintained in the operative state; when a volume is identified as containing only data which has become inactive, that inactive volume is transferred from the active set of drives and stored across a plurality of drives being a second number of drives within an inactive set of the plurality of drives which are normally maintained in the inoperative state; when there is a subsequent read or write request in respect of an inactive volume stored within the inactive set of drives, the inactive volume is transferred from the inactive set of drives to the drives in the active set of drives and becomes an active volume; and wherein the data storage layouts for the active set of drives and the inactive set of drives are different, and the data storage layout for the inactive drives includes a plurality of regions at predetermined different levels of increasing data storage capacity and is such that (a) when an inactive volume is transferred in its entirety to the inactive set of drives it is allocated to the smallest capacity region that will accommodate the data of the volume; and (b) when additional data only is to be added to a volume on the inactive set of drives the additional data is firstly placed in the current highest capacity region containing data for that volume until that current highest capacity region is full; and if there is remaining data to be added to the volume that remaining data is placed in the lowest capacity region that (i) will accommodate that remaining data and (ii) is of the same capacity as, or a higher capacity than, the currently highest capacity region.

The computer program product may be supplied in the form of physical media such as a CD or DVD containing data, or as data transmitted from a remote location such as over the Internet. The product as supplied my be in compressed and/or encrypted form and may require an activation key or the like to be accessible. The product as supplied may be in the form of an installation set which, for example, firstly copies files to a data processing system—if necessary de-compressing or decrypting them, and then installs a software package on the data processing system.

In respect of these aspects of the invention there are various optional features. For example, preferably a region contains only data for one volume.

Preferably, successive different levels of region differ in data capacity by a factor of 1/δ, where δ is a constant and 0<δ<1. Preferably δ is ½.

In a preferred implementation the drives have disks and in the operative state the disks are spinning and in the inoperative state the disks are stationary.

In a preferred arrangement, when a volume has become inactive, it is firstly transferred to an intermediate set of drives which are maintained in the operative state. In such an arrangement, when the intermediate set of drives contains sufficient inactive volume data, that inactive volume data may be transferred from the intermediate set of drives to the inactive set of drives. Alternatively, when the intermediate set of drives contains sufficient inactive volume data, the intermediate set of drives joins the inactive set of drives and is placed in the inoperative state.

In a preferred arrangement, an inactive volume spans a smaller number of drives in the inactive set of drives than the number of drives in the active set of drives that the volume spanned when active.

In a preferred arrangement, the total amount of data space in the inactive set of drives occupied by an inactive volume is less than the total amount of data space in the active set of drives that was occupied by the volume when active. For example, the data stored on inactive drives may incorporate parity or other reduced overhead coding information.

In preferred embodiments, the data storage layout in the active set of drives provides a higher level of redundancy than the data storage layout in the inactive set of drives.

In preferred embodiments, the data storage layout in the active set of drives provides a higher speed of data throughput when writing or reading data, than the data storage layout in the inactive set of drives when drives in the inactive set are operative so that data for inactive volumes can be written to or read from the drives.

In some embodiments, a drive in the inactive set of drives holds regions of the same level.

It will be appreciated that other aspects of the invention disclosed herein may also be expressed as a method, an apparatus configured to carry out the method, and a computer software product for configuring data processing means of the apparatus to carry out the method.

By way of example, a further aspect the invention provides a method of storing data on a plurality of physical data storage drives, each of which can be switched between an operative state and an inoperative state; wherein an active volume containing data which is currently active is stored across a first number of drives in an active set of the plurality of drives which are normally maintained in the operative state; when a volume is identified as containing only data which has become inactive, that inactive volume is transferred from the active set of drives to a second number of drives within an inactive set of the plurality of drives which are normally maintained in the inoperative state; when there is a subsequent read or write request in respect of an inactive volume stored within the inactive set of drives, the inactive volume is transferred from the inactive set of drives to the drives in the active set of drives and becomes an active volume; and wherein the data storage layouts for the active set of drives and the inactive set of drives are different, preferably such that the first number of drives in the active set for holding a volume when active, is greater than the second number of drives in the inactive set for holding that volume when inactive

In preferred embodiments of aspects of the invention, each drive includes a movable data storage component, such as a rotating disk, and in the inoperative state this is stationary. However, there could be arrangements in which, for example, a disk is rotating at a relatively low, standby speed when in the inoperative state. In general, the invention is applicable to other forms of storage which do not require moving components, including solid state memory such as Flash, and types of storage yet to meet with commercial acceptance such as those based on biochemical technology, in which there is an operative state requiring a relatively high energy consumption and an inoperative state requiring a relatively low energy consumption.

In preferred embodiments of some aspects of the invention, when volumes are identified as containing only data which has become inactive, and are to be transferred from the active set of drives to a second number of drives within an inactive set of the plurality of drives which are normally maintained in the inoperative state, the inactive volumes are transferred firstly to an intermediate set of drives which are maintained in the operative state; and when the intermediate set of drives contains a predetermined amount of data for inactive volumes, the inactive volumes are transferred from the intermediate set of drives to the inactive set of drives.

A significant feature of some aspects of the invention is that at any time not only is the number of drives in the active set kept small, but also the number of drives spanned by an inactive volume is kept small. Initially, this is because there are different data storage layouts for the active set of drives and the inactive set of drives. However further reductions in the number of drives for the inactive volumes may be obtained by rebalancing data on the inactive set of drives, in a manner similar to defragmentation, and/or by specifying regions of the drives in a particular manner as described later, and spreading an inactive volume across those regions so as to occupy only a small number of disks.

Embodiments of the invention provide a drive system having the ability to relocate data dynamically between operative (e.g. spinning) and inoperative (e.g. spun down or turned off) drives in order to save power without reducing performance. Drives may be added to and removed from the active set of drives as needed. Such systems operate continuously to relocate data depending on activity and demand so as to concentrate active data onto a small number of active drives. The transition of data to and from the active and inactive sets of drives is managed in such a way that the data on active drives can be accessed with high performance, and the data on inactive drives can be accessed with a small number of requests for drives to become operative (e.g. spun up). The system has the capability of providing substantial power savings without reducing significantly the performance for active data.

In general, some aspects of the present invention provide a disk drive system for substantially reducing power consumption by spinning down disks or turning disks off, without adversely affecting performance of data operations. Such embodiments achieve this by exploiting the characteristics of typical enterprise storage requirements, which are a large fraction of inactive data and regular low load conditions. Such embodiments move and concentrates the active data load to a smaller subset of operative, or “hot” disks, allowing the remaining disks to spin down and become inoperative or become “cold”. The active set is constantly changing, and the preferred embodiments achieve this efficiently, without substantial overhead, and without harming performance (e.g. by not incurring unpredictable spin up delays when accessing data from an active volume). A key feature of preferred embodiments is to partition the physical drives into two sets: hot and cold. All hot drives will be active, and all cold drives will be inactive. The preferred embodiments use different data layouts for the blocks of volumes in these sets. All active volumes will be stored on active drives. In addition, a small set of drives are designated as “warm”, which are active but do not store active volumes. When a warm drive contains a sufficiently large amount of data from inactive volumes, it may be deactivated. When data is to transitioned from active to inactive drives, it is relocated first onto warm drives, which are subsequently deactivated. The layout for active volumes is optimized for high throughput, using for example a redundancy factor of two to store active blocks. The layout for inactive volumes is optimized so that for each inactive volume, its blocks span a small number of physical drives.

Viewed broadly from one aspect, the invention provides a method for managing data storage organised as volumes, consisting of data blocks, by dynamically relocating data between active and inactive physical storage devices using indicators of volume activity/inactivity, in which volumes can dynamically change size.

Viewed broadly from another aspect, the invention provides a system for handling data organised as volumes which contain a number of blocks and may change size dynamically, wherein active volumes are on active drives using a first data layout that allows for high performance using a relatively high redundancy factor, and inactive volumes are on inactive disks using a second data layout using a relatively low redundancy factor. In a preferred arrangement, inactive volumes span at most twice the number of disks required to hold the data of the inactive volumes.

In aspects of the invention, each volume may also contain one or more sub-volumes (a subset of its blocks), and each volume or sub-volume may be active or inactive independently, in which case a volume is said to be active if at least one of its sub-volumes is active. In preferred embodiments of the invention, the data layouts for active and inactive sub-volumes volumes are respectively those of their parent volumes.

One use for a sub-volume is to store a small number, k, blocks (for some integer k) that are often accessed the volume is active, and to optionally keep such a sub-volume active at all times. The identities of blocks in a sub-volume can be recorded in an indexing structure, maintained in memory (as a list of block identifiers), or in external memory (for example, in a B-tree). The sub-volume may be maintained by, for example, using a least recently used (LRU) cache that sees all blocks accessed in the volume, to decide which blocks to keep in and evict from the sub-volume.

In addition, there is provided a special type of volume that is referred to as an ‘active archive volume’. In this case, the volume is kept inactive and typically stored in regions on spun-down disks. One or more sub-volumes are maintained that represent the ‘working set’ of the volume, using the LRU method above. In the event of a read request to the volume, the block that is read (after possibly spinning up the disk) is copied to the hot set and added to one of the sub-volumes. If there are no more accesses to the volume that do not lie within one of its active sub-volumes within a specified time period, the disk can be subsequently deactivated (unless another volume requires it to be active).

Preferably, for each volume on inactive drives, its blocks span close to a minimal number of inactive drives. Preferably, for each inactive volume, its blocks are stored with a low-density redundant code, with a desired level of redundancy. Inactive volumes may be stored in regions, spread over inactive drives by way of an allocation process. For example, regions may be specified at levels of diminishing size by powers of 2, such as an upper level of size 1, and then levels of 1/2, 1/4, 1/8 and so forth. This can stated in a formal way as a level-i region having size equal to a fraction ½ⁱ of the blocks of a drive. Optionally, the regions may be distributed uniformly over c distinct drives, according to a desired level of redundancy c. A region allocation process may comprise choosing greedily a drive with sufficient remaining capacity for the region. In accordance with some embodiments of aspects of the invention, a region allocation process for the inactive drives comprises assigning to each drive a level, and where a level-i drive contains 2ⁱ level-i regions, and the region allocation process for a level-i region comprises choosing a level-i drive with an unused free region.

In general, there may be a predetermined definition of region sizes for holding the data of inactive volumes, such that there is a plurality of fixed levels of region size. The definition of the region sizes could be in accordance with powers of 2 as described above, and generally it may be a matter of choice as to whether for computational purposes there is a lowest level with size 1 and higher levels of increasing size 2, 4, 8, 16 and so forth up to the maximum space of a single drive; or whether as proposed above there is a level of size 1 which is (approximately) the maximum space of a single drive and the other levels are defined as smaller sizes 1/2, 1/4, 1/8 and so forth. For labelling levels, it may be desired to have a level 0 rather than start with a level 1. Higher level labels may indicate higher sizes, or lower sizes. For the purposes of the following discussion, a lower level is one that accommodates more data than a higher level—so for example level 0 has space for containing the most data and levels 1, 2 and 3 etc have successively less space for containing data.

Other ways of defining possible region sizes could be in accordance with another sequence such as the powers of another number, or the Fibonacci sequence or the inverse Fibonacci sequence 1, 1, 1/2, 1/3, 1/5, 1/8, 1/13, . . . or the inverse Harmonic sequence 1/1, 1/2, 1/3, 1/4, 1/5, . . . etc. In general, there needs to be a function that defines discrete region levels of different sizes. This could be levels whose sizes increase successively by doubling, or more generally regions where instead of powers of 2 there is used 1/δ, where delta is a constant between 0 and 1 (or 0<δ<1). Choosing delta=½ will result in region sizes doubling between levels.

However, in a general sense it would be possible to use any size of region that will accommodate the data of a volume. For example for a volume of size s, allocate a region size s or 2s and so forth. In a more general sense, allocate a region whose size is equal to the smallest power of 1/delta greater than s. Preferably, delta is then ½. In an alternative approach, chooses a disk that can accommodate the entire volume. This could be done in various ways—choose the disk with the most free space that can accommodate the volume, choose the disk with the least free space that can accommodate the volume, or choose randomly a disk that can accommodate the volume.

In preferred arrangements, using for example the system of region levels whose size is determined by powers of 2 or the like, when a volume is to be made inactive for the first time, it will normally be allocated to the highest-level region that will accommodate all of its data. That region will be accommodated on the minimum number of physical drives in accordance with the level of redundancy provided by the data system for inactive volumes. Thus, in a typical system there will be two drives involved in storing data for a region although it is not necessary that all of the data needs to be replicated on each of those drives to provide the desired level of redundancy. It will be appreciated that in some cases, there may be a volume of data which is larger than the top level (in terms of size) region, such as level 0. In that case, the volume must be allocated to a plurality of level 0 regions. As a general rule, once some data from a volume has been allocated to a region, none of the data for that volume is allocated subsequently to a smaller size region. Thus, for a volume whose data exceeds the space of a level 0 region, it will occupy only one or more additional regions which are also of the top level. Nevertheless, if it is known that a particular volume is unlikely to increase in size beyond a certain predefined amount, because of the nature of the data it contains (for example because it is read-only), it might be allocated to increasing size regions and the remainder to a single smaller-size region which will accommodate all of that remainder.

When an inactive volume is made active, there are two possibilities. The first is that the volume data is copied to the active drives and removed from the inactive drives. Under such an arrangement, once the volume is made inactive again the technique for allocating the volume to one or more regions is the same as for when a volume is made inactive. The second possibility is that when the volume is made active the volume data is copied to the active drives but is also left on the inactive drives. When the volume is made inactive again, only changes in data need to be added to the inactive drives. Additional data will initially be written into the remaining space in the largest size region already occupied by that volume. Once that existing region is filled, a new region is allocated for the remaining data. The arrangement may be such that the new region is the next largest size region from the existing largest size region that will accommodate the remaining volume data (unless the largest size region is already the maximum size of region). If the remaining data would occupy more that the maximum size region, the level chosen for additional data will also be the maximum size level.

The general rule could be that for regions below the maximum size, a volume can only occupy one region at a particular level. However, in another arrangement, if the same level region as the existing highest region occupied would accommodate the remaining volume data, then a second region at that existing level may be created. The arrangement may be such that, for region levels below the maximum size possible, there is a limit on the number of regions of a given level that a volume may use. For example, this could be two. In such an arrangement, the system chosen can be such that the level of region chosen for remaining data once an existing region level is full, is the lowest level of region that is at least greater than or equal to the greater of (a) the size of the remaining data and (b) the existing size of the volume. This means that if the volume already occupies two regions (at the same level, or one higher and one lower), then the new level of region chosen must be higher than the existing highest level for the volume. If the volume currently only occupies one region, the same level of region can be chosen if it is large enough to accommodate the additional data.

One way of expressing this is to say that if there is an amount x of data remaining to be copied, and an amount w of data already exists on the inactive drives due to this volume, then choose the largest integer j such that ½^{j}>=max(w, x)—where w and x are both between 0 and 1, as disks have a size 1 in this analysis.

In preferred embodiments of the invention, a particular physical drive handles only regions of a particular level. Thus, there will be drives handling only level 1 regions, drives handling only level 2 regions and so forth.

In embodiments of aspects of the invention, each active volume or sub-volume has all of its blocks reside on active drives and is accessible without requiring the activation of any inactive drive. For each active volume or sub-volume, each block is replicated once or more over the active drives, in accordance with a desired active volume block layout.

In embodiments of aspects of the invention, when an inactive volume becomes active, its data is moved from inactive drives to a set of active drives, possibly including the existing active drives, and the data is rebalanced across the active drives according to the desired active data layout. The existing data for an inactivated volume which has been activated, may be kept on the inactive drives, so that on deactivation of the volume again, only the data that has changed need be copied back to the inactive drives. This reduces the amount of data that has to be transferred and the length of time for which the inactive drives must be made active in order to receive the amended data.

In embodiments of aspects of the invention, if as the result of activating a volume or a volume growing in size, the current set of active drives is not large enough to support the active data, additional drives are added to the active set. Preferably, the additional drives are chosen in the following order of preference: 1) from unused active drives if available, and 2) if unused active drives are unavailable or become unavailable, from the set of active drives. In such a case, preferably the additional inactive drives are chosen by selecting those inactive drives with the maximum amount of free space or space already devoted to storing additional copies of the active data that can be erased. If the number of drives is not sufficient to support the desired level of redundancy, a paging (caching) algorithm may be applied to determine which blocks are stored with a higher level of redundancy.

It will be appreciated that the prior art referred to above does not disclose or suggest the features and combination of features discussed above. For example, none of the file or block migration techniques modify the data layouts to optimize for the different needs of inactive and active data, and in particular the need to minimize the number of disks spanned by an inactive volume. These systems do not migrate inactive data between sets of drives having different data layouts. Similarly, MAID makes no attempt to reorganise the data layout; thus there will be many data patterns that only require access to a small fraction of data, but because the layout is static, will require spinning up many disks.

Some embodiments of the invention will now be described by way of example and with reference to the accompanying drawing, which is an outline of a system in accordance with the invention.

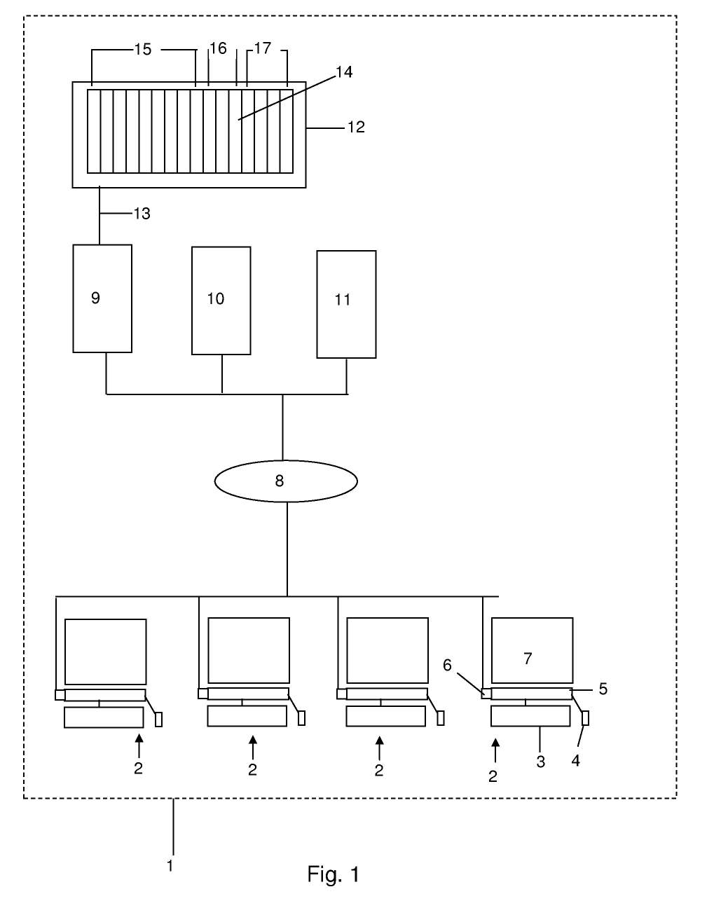

Referring now to FIG. 1, there is shown a data processing system 1 of a type that may be found in an organisation. A plurality of data processing terminals 2 are provided for users, each having data input means, for example in the form of a keyboard 3 and a mouse 4, a processing unit 5 containing a processor, volatile memory, non-volatile memory such as a hard disk for storing operating system and application software, a network interface 6, and output means in the form of a display 7. By means of the network interface 6 the terminals are connected to a wired and/or wireless local area network 8. To this are connected, for example, a number of servers 9, 10 and 11. Server 9 is a print/file server and is connected to a data storage system 12, for example by means of a fibre channel connection 13. Data which is created by or to be accessed by applications running on any of the terminals 2 is stored on the data storage system 12. The data storage system contains a number of disk drives 14. Some of these drives are designated as active, or “hot” drives 15; some are designated as intermediate or “warm” drives 16; and some are designated as inactive or “cold drives” 17. The individual drives 14 may change their role and the number of drives in a particular set—hot, warm or cold, can adapt as necessary.

Active data is written across a relatively high number of the active drives 15, providing a relatively high level of redundancy, and these active drives may for example be in a RAID array. In the manner described in more detail below, inactive data is written across a relatively low number of the active drives 17, which have a different data layout and provide a lower level of redundancy. In this embodiment, inactive data is transferred first to the intermediate drives before being transferred to the inactive drives, as described below. In this embodiment of the invention, data is organised into volumes and whole volumes or sub-volumes are made inactive and active.

Dealing now with the arrangement of the drives and how data is handled in more detail, there will first be considered the physical storage drives.

Assume that there is a set of n identical unit-capacity physical drives. The actual physical drives may be of different capacities, so the unit-capacity drives are obtained as follows. Assume the smallest drive has capacity 1 (by rescaling capacities). Fix a small constant 0<δ≦1 so that 1/δ is an integer and for each physical drive of capacity x, divide it into |x/δ| slices each of size δ and at most one remaining slice of size <δ, which is discarded. Doing this for each physical drive gives a set of uniform-capacity slices that are used as the drives (and again capacities are rescaled to be 1).

Data is stored in units called blocks, which is the smallest unit of data that will be accessed on a drive. Each block has a logical size of 1/c, which is an amount of space on the drive that depends on the application (some applications may prefer to use large block sizes, for example). Each drive has the same number of blocks, numbered from 1 through to c, for some integer c (bearing in mind that the capacity of all drives has been rescaled to 1).

Drives are either inactive or active, and can take time to transition between these two states. Blocks can only be retrieved when a drive is in the active state. It is assumed that drives consume significant power in the active state, and little or no power in the inactive state.

Turning now to volumes, there follows a method to emulate a set of volumes V={V₁, . . . , Vₘ}. Volumes may have different sizes, and the size of volume i, denoted s(i), is the total capacity of the blocks is contains. Each block is assumed to be identical to the blocks on drives, so has capacity 1/c. Volumes can grow in size, and the method described below assumes all volumes begin with size 0, and grow as new blocks are added or written to them.

Each volume can be marked active or inactive by an application or by a user. A volume must first be marked active before requests for any of its blocks can be issued to the system. If a request arrives for an inactive volume, it is implicitly assumed to be preceded by marking the volume as active.

In accordance with this embodiment of the invention, a significant feature is that the drives are divided into three sets: hot, warm, and cold. All hot drives will be active, and the cold drives will be inactive. Different data layouts are used for the blocks of volumes in these sets, as described below. All active volumes will be stored on active drives. In addition, a small set of drives are designated as warm, which are active and can store both active and inactive data. When a warm drive contains a sufficiently large amount of data from inactive volumes, it may be deactivated, in which case it becomes a cold drive. When data is transitioned from active to inactive drives, it is relocated first onto warm drives, which are subsequently deactivated. The system provides and implements commands for moving data between specified locations on drives. The system provides inactive/active signals (or indicators or otherwise) for volumes. These can be based on simple inactivity timers (or timeouts), and/or on mount/unmount or similar signals from clients and applications accessing the volumes.

Blocks for active volumes will be stored across several or all of the hot drives, in a layout that is typically optimized for high throughput and performance. To this end, each such block may be stored several times, on different hot drives, to achieve the desired throughput and redundancy level. For example, existing data layouts such as the various RAID layout can be used to stripe these blocks across the hot drives. In general, the storage layout and the number of disks used to store a particular active volume will be chosen to provide both high throughput and security. For an inactive volume, high throughput is not an issue.

The following describes the layout imposed on the cold drives, which makes it possible to maintain a compact layout for the inactive volumes while using a close-to-minimal number of devices. This is not to exclude other layouts that achieve the same goals.

The layout for inactive volumes should be that for each inactive volume, its blocks can be accessed by requests to a small number of distinct drives, while still being spread over enough disks to achieve the desired redundancy and fault-tolerance. The blocks themselves may be stored with different data layouts, such as a RAID layout, or using a more involved coding scheme such as one bases on a low density parity check (LDPC) code, for example. The exact layout of blocks within regions (as described below) depends on the code used to store the blocks, and the level of redundancy chosen, which may be volume-specific. To this end, it may be possible to compress or “de-duplicate” data on cold drives in order to save space. The actual encoding scheme used is not considered further here.

Volumes are stored on cold drives in a number of regions. Each region has a level, which is an integer at least 0. A level-i region has size equal to a fraction ½ⁱ of the number of blocks on a drive. Each region contains blocks for either zero volumes (in which case it is a free region) or at least one volume (in which case it is an occupied region). Regions with no unused blocks are called full regions. A region with at least one block from a volume i is said to be a volume-i region. A region may be spread over one or more drives. The blocks of a region may be distributed arbitrarily or in some structured fashion over its drives, depending on the characteristics of the drives. Within a region, its blocks may be stored in a contiguous region on a drive, or in a more complicated fashion, depending on the characteristics of the drive used.

A data structure in memory (or for example on a tertiary storage device) that counts, for each region, how many blocks are used in that region, and over which drives they are spread.

There will now be discussed the region allocation process. When a new level-i region is required, there is an allocation process that determines, given the set of current cold and warm drives, how a new level-i region should allocated from the warm drives. For example, a new level-i region may be allocated by finding any warm drive that contains enough space for the whole region; and if no such warm drive exists, find any cold drive (including any currently unused drives) that contains enough space for the whole region; and if no such cold drive exists, either spread the region over several warm drives, or rearrange (perform “compaction” as described below) the data on the cold and warm drives so that a warm drive exists with enough space for the region. Another option, for example, is to “slice” the region into several parts, say five parts, and uniformly spread these parts over different drives. Such a slicing would allow for redundancy and failure-tolerance in the encoding of the inactive volumes, by storing them on different drives.

The system needs to have a sufficient amount of storage available to meet the demands of active volumes. The desired method may have several different implementations, depending on how much storage is available to the system.

There will now be considered volume-drive block mapping. For each volume i, store (either in memory or on tertiary storage) a dictionary that stores, for each block j of volume i, the identifier of the drive and the block number on the drive at which block j of volume i has been stored. This can be implemented, for example by using a B-tree or other search tree method.

In respect of volume activation, Let H₁ be the set of hot drives before activating volume i. When a volume i is activated, the following process is carried out. Find a set of inactive drives, say C that will allow the system to recover all the data for the volume (bearing in mind that some of the data may exist on active drives and warm drives), and activate all these drives. Depending on the coding scheme used to store the blocks on cold drives, there may be several possible choices for C. In this embodiment, the smallest such set is chosen. Assume there are now n=|H₁|+|C| hot drives, as a result of activating those in C.

There is now all the active data available for access, so that read requests can proceed immediately to the active data. Write requests (to write new blocks) can either be buffered and directed to the set S described below, or can be directed to the current location of the volume data.

It is now necessary to partially reorganise the data in the hot set so that it has the desired layout, and to ensure that the hot set has not grown too large. To this end, let the set of currently active volumes be A, requiring total amount of space size(A). The value of size(A) depends on the size of the active volumes and the desired redundancy needed to encode their blocks on the active drives. If there are additional requirements, for example that each block must have two copies on different drives, then size(A) should be taken large enough so that this is possible (recalling that each drive has size 1). It should be the case that size(A)≧|H₁|. If size(A)>|H₁|, then the hot set needs expanding (for example due to the increased redundancy required for the active volumes). In this case, there must now be found a new hot set S of drives of size at least n′ that has sufficient space to store the active data. Depending on the number of unused drives available (i.e. how over-provisioned the system is), some drives in C may be kept in the set S.

For a set C of drives, let free(C, A) be the amount of free space on C that can be devoted to active volumes A (i.e. data already used by A, plus unused space). If free(C,A)≧size(A), it can be said that the set C can support A.

If there is a set of unused drives such that D∪H₁ can support A, let S=D∪H1 and rebalance the data from active volumes across the new set S according to the desired active data layout. Depending on the particular embodiment, it may be desirable to activate several unused drives, to reduce excessive future rebalancing. For example, add [tn]unused drives on each growing of the hot set for some small constant tε(0, 1) for example t=0.1.

If the above is not possible, but there is a set of unused drives D and a subset C′⊂C such that C′∪D∪H₁ can support A, set S=C′∪D∪H₁ and rebalance the data from active volumes across the new set S according to the desired active data layout. In this case, select C′ as the smallest such subset that satisfies the above. Note that the regions in C′ corresponding to active volumes in A can be erased, as their only purpose was to reduce the amount of data transferred from hot to cold drives on deactivation of the active volume.

If neither of the above is possible, it is necessary to reduce the size of the active data. Let D be the remaining set of unused drives (possibly empty), set S=C∪D∪H₁ and rebalance the data from active volumes across the new set S according to the desired active data layout. In this case, the redundancy of some active volumes will be reduced, while ensuring that every active volume has at least one copy of each block on the active drives. In one embodiment, a paging algorithm such as LRU (least-recently-used) may be used, for example as follows. If there is space on the hot drives for say x blocks in total, and y blocks are needed in order to store at least one copy of each active volume's blocks, then it is envisaged having a cache of size x-y, storing the least-recently-used (or most-often-used, or otherwise, depending on the desired embodiment) x-y blocks. Blocks in the cache are to be stored twice on the hot drives, and blocks not in the cache are stored only once.

Once the set S has been selected, in the background or otherwise, the blocks of the activated volume are copied onto the drives in S, as per the desired data layout. For example, in one embodiment, every block of volume i may exist twice in S, with no pair of the same block on the same drive (this can be done, for example by choosing random permutations of size n′ for each set of n′ blocks to be rebalanced). The volume-block mapping must be updated to reflect this.

There remains what happens to the drives in the set C.

For drives in C∩S: When a previously cold drive is added to the hot set, it may contain regions for inactive volumes. In this case, these regions are moved to drives in the warm set, by performing the deactivation method described below for the sub-volume specified by the region. A simpler but less efficient method is to allocate a new region of the same size and move the data into this new region.

For drives in C\S: These drives are directly added to the warm set, and subsequently deactivated according to the process described later for the warm set. Depending on the level of provisioning, the regions corresponding to active data may or may not be erased. If they are not erased, it should be noted that in this case, when those volumes are next deactivated, they will be split across hot and cold drives, and the blocks that will need to be transferred to the cold disks will only be those that have changed, or have been added to the volume.

Volume deactivation will now be considered. In what follows, when volumes are said to be deactivated, it is understood that “volume” may also mean “sub-volume of volume i” or “fragment of volume i”, in which case the volume i is split across hot and cold drives, and some of the volume i may be left on active drives. For example, if a volume is split and contains the set blocks B₁ on cold drives and B₁∪B₂ on hot drives, then it is only necessary to deactivate the fragment containing blocks B₂, and hence the deactivated fragment will have size equal to the number of blocks in B₂.

Recall that drives have size normalised to 1. For the purposes of this operation a deactivated volume (or sub-volume) i has size 0≦s(i) equal to the total fraction of blocks on a drive that is needed to encode the volume (or sub-volume) onto the inactive drives. The computation of the size can be done by knowing the parameters of the coding scheme (for example, its rate, or how many parity bits per data bits, etc.).

When a volume i is deactivated, if volume i not split across active and inactive drives at the time of deactivation, then let level(i)=max {0, j}, where j is the largest integer such that ½^{j}≧s(i). If level(i)=0 then volume i is deemed to be a large volume, otherwise it is a small volume. A new level-j region is allocated. If i is a small volume, it will fit entirely into this region. If it is a large volume, it may require several regions; in this case it is possible to simply refer to these as a single region of size equal to the total size, and assume that the data will be spread in some chosen way across these drives. Copy from the active drives the data from each block of volume i into the region(s) just allocated.

If volume i is split, let level(i) be the highest level of a volume i region. If level(i)=0 then the volume i is deemed a large volume, otherwise it is a small volume. Activate the set of drives containing the level (i)-level region of volume i, and where those drives still have free blocks in the volume i region. Copy the (possibly encoded) volume i blocks from the active drives onto the volume-i region until the region has used all its allocated space, or until all blocks have been transferred. If the region is full but there remain blocks to be copied, the following is done. Let the remaining data have size x, recalling that x is the fraction of the total number of blocks on a disk, being between 0 and 1. Let j be the largest integer such that ½^{j}≧max (x, w). Allocate a new level-l region and copy the remaining blocks into this free region. If j=0 then several level 0 regions may be allocated to store the remaining blocks. The volume-block mapping must be updated to reflect this copying.

The system marks as free the space previously occupied by all the copied blocks on the active drives. As in the volume activation process, let n be the current size of the hot set and compute the new number nⁱ active drives required. If nⁱ<2n/3 then a subset S of the drives is chosen to become inactive (for example, by choosing a subset with the largest number of currently inactive blocks), and the active blocks are re-balanced across S. The drives not in S can then be marked inactive and deactivated, or alternatively marked warm and added to the warm set, to be deactivated later.

From time to time, it will be desirable to perform warm drive compaction as the warm set grows too large. A level-j region for a volume i in W is called complete if i is inactive, or there are no volume-i regions of a higher level than j. A drive in W is deemed complete when all its regions are either complete or unused. When a warm drive becomes complete, it is deactivated and becomes a cold drive. Whenever the regions on warm drives can be relocated among the warm drives so that it leaves at least one drive either empty or with all its regions complete, then the regions are relocated to achieve this. For example, the system can select the warm drive with the maximum number of complete or unused regions, and then move all its non-complete regions onto the remaining warm drives.

The size of the warm set may further be reduced by the following steps, particularly when there are many long-lived active volumes. A timeout t is fixed, which is an integer number of seconds, at least twice the activation delay of an inactive drive. When a volume i has been active for at least a time t, all its regions on the warm drives are marked as complete. One change is needed to the volume deactivation method: when volume i is marked as inactive, the cold drive containing its lowest-level (meaning largest size) region (if volume i is split between active and inactive drives) is activated, so that W contains at least one region occupied by volume i as desired.

Periodically, it will be necessary or desirable to reorganise the data layout on cold drives, in order to reduce the space consumed, or to optimize the layout so that fewer spin ups are required in future. For example, if some subset of volumes, say V′, are regularly activated together, the regions they occupy may be moved so that for each level, regions of the same level occupied by V′ span a small number of cold disks. In order to reduce the space consumed by cold data, it is possible to apply a compaction procedure very similar to that described above for the warm set of drives.

A region in the context of this description generally means a storage area that has a predetermined capacity. Data for an inactive volume will be written into that region and there may be space left in the region for additional data for the volume to be added when the volume has expanded, until the region is full. After that, additional data for the volume must be stored in a different region, which will have a predetermined capacity and in most cases the additional data will initially take up a proportion of that capacity. A “volume” of data does not just mean an arbitrary amount of data, and a region does not just have a capacity which is that of the volume (or part of the volume) which it stores. A region has a predetermined capacity, and different level regions have different predetermined capacities, and the volume data is written into the required capacity.

1. A method of storing data on a plurality of physical data storage drives, each of which has a data storage component and can be switched between an operative state in which there is relatively high energy usage, and an inoperative state in which there is relatively low energy usage; wherein an active volume containing data which is currently active is stored across a plurality of drives being a first number of drives in an active set of the plurality of drives which are normally maintained in the operative state; when a volume is identified as containing only data which has become inactive, that inactive volume is transferred from the active set of drives and stored across a plurality of drives being a second number of drives within an inactive set of the plurality of drives which are normally maintained in the inoperative state; when there is a subsequent read or write request in respect of an inactive volume stored within the inactive set of drives, the inactive volume is transferred from the inactive set of drives to the drives in the active set of drives and becomes an active volume; and wherein the data storage layouts for the active set of drives and the inactive set of drives are different, and the data storage layout for the inactive drives includes a plurality of regions at predetermined different levels of increasing data storage capacity and is such that (a) when an inactive volume is transferred in its entirety to the inactive set of drives it is allocated to the smallest capacity region that will accommodate the data of the volume; and (b) when additional data only is to be added to a volume on the inactive set of drives the additional data is firstly placed in the current highest capacity region containing data for that volume until that current highest capacity region is full; and if there is remaining data to be added to the volume that remaining data is placed in the lowest capacity region that (i) will accommodate that remaining data and (ii) is of the same capacity as, or a higher capacity than, the currently highest capacity region.

2. A method as claimed in claim 1, wherein when there is the remaining data to be added to the volume that remaining data will only be placed in a region of the same capacity as the currently highest capacity region, if that is the only region containing data for the volume.

3. A method as claimed in claim 1, wherein a region contains only data for one volume.

4. A method as claimed in claim 1, wherein successive different levels of region differ in data capacity by a factor of 1/δ, where δ is a constant and 0<δ<1.

5. A method as claimed in claim 4, wherein δ is ½.

6. A method as claimed in claim 1, wherein the drives have disks and in the operative state the disks are spinning and in the inoperative state the disks are stationary.

7. A method as claimed in claim 1, wherein when a volume has become inactive, it is firstly transferred to an intermediate set of drives which are maintained in the operative state.

8. A method as claimed in claim 7, wherein when the intermediate set of drives contains sufficient inactive volume data, that inactive volume data is transferred from the intermediate set of drives to the inactive set of drives.

9. A method as claimed in claim 7, wherein when the intermediate set of drives contains sufficient inactive volume data, the intermediate set of drives joins the inactive set of drives and is placed in the inoperative state.

10. A method as claimed in claim 1, wherein an inactive volume spans a smaller number of drives in the inactive set of drives than the number of drives in the active set of drives that the volume spanned when active.

11. A method as claimed in claim 1, wherein the total amount of data space in the inactive set of drives occupied by an inactive volume is less than the total amount of data space in the active set of drives that was occupied by the volume when active.

12. A method as claimed in claim 1, wherein the data storage layout in the active set of drives provides a higher level of redundancy than the data storage layout in the inactive set of drives.

13. A method as claimed in claim 1, wherein the data storage layout in the active set of drives provides a higher speed of data throughput when writing or reading data, than the data storage layout in the inactive set of drives when drives in the inactive set are operative so that data for inactive volumes can be written to or read from the drives.

14. A method as claimed in claim 1, wherein a drive in the inactive set of drives holds regions of the same level.

15. An apparatus for storing data, the apparatus comprising a plurality of physical data storage drives, each of which can be switched between an operative state in which there is relatively high energy usage, and an inoperative state in which there is relatively low energy usage; wherein the apparatus comprises data processing means configured such that:
an active volume containing data which is currently active is stored across a plurality of drives being a first number of drives in an active set of the plurality of drives which are normally maintained in the operative state; when a volume is identified as containing only data which has become inactive, that inactive volume is transferred from the active set of drives and stored across a plurality of drives being a second number of drives within an inactive set of the plurality of drives which are normally maintained in the inoperative state; when there is a subsequent read or write request in respect of an inactive volume stored within the inactive set of drives, the inactive volume is transferred from the inactive set of drives to the drives in the active set of drives and becomes an active volume; and wherein the data storage layouts for the active set of drives and the inactive set of drives are different, and the data storage layout for the inactive drives includes a plurality of regions at predetermined different levels of increasing data storage capacity and is such that (a) when an inactive volume is transferred in its entirety to the inactive set of drives it is allocated to the smallest capacity region that will accommodate the data of the volume; and (b) when additional data only is to be added to a volume on the inactive set of drives the additional data is firstly placed in the current highest capacity region containing data for that volume until that current highest capacity region is full; and if there is remaining data to be added to the volume that remaining data is placed in the lowest capacity region that (i) will accommodate that remaining data and (ii) is of the same capacity as, or a higher capacity than, the currently highest capacity region.

16. An apparatus as claimed in claim 15, wherein a region contains only data for one volume.

17. An apparatus as claimed in claim 15, wherein successive different levels of region differ in data capacity by a factor of 1/δ, where δ is a constant and 0<δ<1.

18. An apparatus as claimed in claim 17, wherein δ is ½.

19. An apparatus as claimed in claim 15, wherein the drives have disks and in the operative state the disks are spinning and in the inoperative state the disks are stationary.

20. A computer software product containing instructions which when run on data processing means will configure the data processing means to control an apparatus for storing data, the apparatus comprising a plurality of physical data storage drives, each of which an operative state in which there is relatively high energy usage and an inoperative state in which there is relatively low energy usage; wherein the instructions are arranged to configure the data processing means such that:
an active volume containing data which is currently active is stored across a plurality of drives being a first number of drives in an active set of the plurality of drives which are normally maintained in the operative state; when a volume is identified as containing only data which has become inactive, that inactive volume is transferred from the active set of drives and stored across a plurality of drives being a second number of drives within an inactive set of the plurality of drives which are normally maintained in the inoperative state; when there is a subsequent read or write request in respect of an inactive volume stored within the inactive set of drives, the inactive volume is transferred from the inactive set of drives to the drives in the active set of drives and becomes an active volume; and wherein the data storage layouts for the active set of drives and the inactive set of drives are different, and the data storage layout for the inactive drives includes a plurality of regions at predetermined different levels of increasing data storage capacity and is such that (a) when an inactive volume is transferred in its entirety to the inactive set of drives it is allocated to the smallest capacity region that will accommodate the data of the volume; and (b) when additional data only is to be added to a volume on the inactive set of drives the additional data is firstly placed in the current highest capacity region containing data for that volume until that current highest capacity region is full; and if there is remaining data to be added to the volume that remaining data is placed in the lowest capacity region that (i) will accommodate that remaining data and (ii) is of the same capacity as, or a higher capacity than, the currently highest capacity region.
